(19) United States
(12) Patent Application Publication
(10) Pub. No.: US 2007/0078903 A1
(43) Pub. Date: Apr. 5, 2007

(54) Bookmark managing apparatus and method of managing bookmark

(75) Inventor: William H. Saito, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FORVAL TECHNOLOGY, INC., Tokyo (JP)

(21) Appl. No.: 11/540,508

(22) Filed: Oct. 2, 2006

Related U.S. Application Data
(60) Provisional application No. 60/722,992, filed on Oct. 4, 2005.

(51) Int. Cl. G06F 17/30

(52) U.S. Cl. 707/200

(57) ABSTRACT

In a bookmark managing apparatus, connectable to a service server through a network and to a terminal of a user, for managing a bookmark for each user, bookmark managing information is stored which includes user ID information, connection information of the server, and a cookie for the server, associated with the user ID information. When the user is authenticated, the bookmark managing information of the user is searched to generate and transmit a list of the connection information of the user to the terminal. When receiving selection information indicating the connection information on the list from the terminal of the user, the bookmark managing apparatus makes a connection to the server with the connection information to forward data of the service from the server to the terminal of the user and when receiving a request from the service server for transmitting the cookie, transmits the cookie to the server. Corresponding method is also disclosed.

### CROSS REFERENCE TO RELATED APPLICATIONS

The present application claims priority to U.S. Provisional Patent Application No. 60/722,992, filed on Oct. 4, 2005, the entire disclosure of which is incorporated herein by reference.

### BACKGROUND OF THE INVENTION

1. Field of the Invention

The present invention relates to a bookmark managing apparatus for providing a bookmark for each user and a method of managing bookmark

2. Description of the Related Art

Generally, to refer information, for example, a Web page on a network such as the internet, a desired Web page is displayed by making a connection to the network, starting a Web browser, and entering a URL (Uniform Resource Locator: hereinafter referred to as an address). The Web browser in a terminal has a function for registering the address to omit user's input operations for favorite Web pages and frequently accessed Web pages and to facilitate the next access. Such a function is generally referred to as a bookmark.

On the other hand, Japanese Laid-open Patent Application publication No. 2002-99568 discloses a method of automatically generating and supplying a bookmark for each individual on the basis of a Web page referred by a user or a searching result (paragraphs 0014 and 0015, and FIG. 1).

Further in a Web server for allowing a user to use a service after authentication of the user, is known a method in which a user is required to input user's name and a password for collation in the Web server to allow the user to use the Web page when the input data is correct. To facilitate such a user authentication, it is known that information called a cookie readable and rewritable in response to a request from the Web server is stored in a storage device of a terminal of the user to be used for user authentication as needed.

The cookie is data transmitted from a Web site and temporarily stored in a computer of a visitor to the Web site to store information regarding the visitor, a last date and time of visiting the Web site and the number of visits. The cookie is used to identify the user and can be used in an authenticating system and a personalizing system for customizing a service provided through the WWW for each user.

### SUMMARY OF THE INVENTION

A first aspect of the present invention provides bookmark managing apparatus, connectable to a server that provides a service through a network and to a terminal of a user, for managing a bookmark for each user, comprising: storing means for storing at least a piece of bookmark managing information including user identification information for identifying the user, connection information associated with the user identification information for connection to the server, and a cookie of the server associated with the user identification information; authenticating means for authenticating the user by collating user identification information received from the terminal of the user with the stored user identification information; bookmark managing means for, when authenticating the user is successful, searching a piece of the bookmark managing information associated with the user identification information received from the terminal of the user to generate a list of the connection information of the user to transmit the list to the terminal; and connecting management means for connecting the bookmark managing apparatus to the server with the connection information associated with the user when selection information indicating that the connection information is selected is received from the terminal of the user to cause the server to provide data of the service to the terminal of the user and for transmitting the cookie to the server when receiving a request for transmitting the cookie.

A second aspect of the present invention provides a method of managing a bookmark of a server for providing a service to a terminal of a user through a network, comprising the steps of: storing at least a piece of bookmark managing information including user identification information for identifying the user, connection information associated with the user identification information for connection to the server, and a cookie of the server associated with the user identification information; authenticating the user by collating user identification information received from the terminal of the user with the stored user identification information; when authenticating the user is successful, searching a piece of the bookmark managing information associated with the user identification information received from the terminal of the user to generate a list of the connection information of the user to transmit the list to the terminal; and making a connection to the server with the connection information associated with the user when selection information indicating that the connection information is selected is received from the terminal of the user to cause the server to provide data of the service to the terminal of the user and transmit the cookie to the server when a request for transmitting the cookie is received.

### BRIEF DESCRIPTION OF THE DRAWINGS

The object and features of the present invention will become more readily apparent from the following detailed description taken in conjunction with the accompanying drawings in which:

FIG. 1 is a block diagram of a network system including a bookmark managing apparatus according to an embodiment of the present invention;

FIG. 2 shows a table for illustrating user information in a Web server;

FIG. 3 shows a table of user information stored in the bookmark managing apparatus according to the embodiment of the present invention;

FIG. 4 shows a table of bookmark managing information stored in the bookmark managing apparatus according to the embodiment of the present invention;

FIG. 5 is a flowchart of managing bookmarks according to the embodiment of the present invention;

FIG. 6 is an illustration of a bookmark display screen image according to the embodiment of the present invention;

FIG. 7 shows a table of the bookmark managing information stored in the bookmark managing apparatus according to a modification of the present invention;

FIG. 8 depicts a modified step of the flowchart shown in FIG. 5 according the present invention;

FIG. 9 depicts another modified step in the flowchart shown in FIG. 5 according the present invention; and

FIG. 10 depicts a still another modified step in the flowchart shown in FIG. 5 according the present invention.

The same or corresponding elements or parts are designated with like references throughout the drawings.

### DETAILED DESCRIPTION OF THE INVENTION

Prior to describing an embodiment of the present invention, the above-mentioned related art will be further argued.

According to the WWW (World Wide Web, also referred to as Web) server described in Japanese laid-open patent application publication No. 2002-99568, though a user accesses to the internet with a different terminal other than the terminal owned by the user, the user can access a desired Web page using a bookmark stored in the WWW server. However, because the cookie is stored in the terminal owned by the user, when the user uses the different terminal to access a Web server that authenticates the user with the cookie, the user is required to send authentication information, so that the operation becomes difficult.

To simplify the difficult operation, the inventor developed a bookmark managing apparatus, a method of managing a bookmark, and a computer program for managing a bookmark to use the cookie obtained by the user though the user accesses a network with the different terminal.

With reference to drawings will be described an embodiment of the present invention in details.

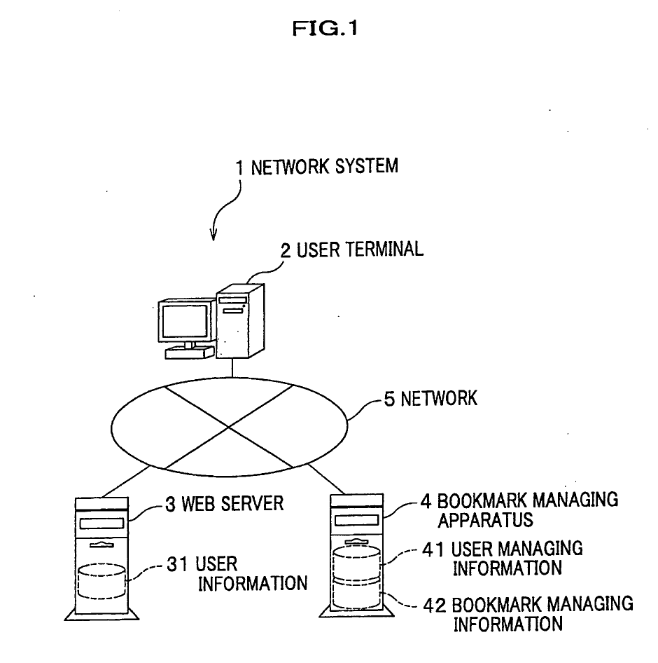

FIG. 1 is a general block diagram of a network system including a bookmark managing apparatus 4 according to an embodiment of the present invention.

The network system 1 includes, as shown in FIG. 1, a user terminal 2 used by a user, a Web server 3 which the user desires to access for login, and the bookmark managing apparatus 4 for managing a bookmark and a cookie for each user, which are connected to each other through a network 5.

In FIG. 1, only one user terminal 2 is shown. However, a plurality of user terminals 2 accessible to the bookmark managing apparatus 4 and the Web server 3 are connectable.

User Terminal

The user terminal 2 is provided for receiving a service from the Web server 3 through the network 5 after connection. The user terminal 2 includes a RAM (Random Access Memory), a ROM (Read Only Memory), a hard disk drive, a CPU (Central Processing unit), input devices such as a mouse and a keyboard, a display, and a LAN (Local Area Network) card for communication interface. As the user terminal 2, for example, are available a note type or disk-top type of personal computer, a PDA (Personal Digital Assistant), and a cellular phone having a function for connection to the internet. The user terminal 2 may be owned by the user or shared.

The hard disk drive of the user terminal 2 stores, in addition to an OS (Operating System), a Web browser to operate the user terminal 7 connectable to the network 5 by executing a program of the Web browser loaded onto the RAM by the CPU of the user terminal 2.

The Web server 3 is a terminal including storage devices including a RAM, a ROM, and a hard disk drive, a CPU, and a LAN card for communication interface to supply a service to users through the network 5 as a sever. For example, a server type of computer can be used as the Web server 3.

The hard disk drive of the Web server 3 stores a service program for supplying a service and a user authentication program for user authentication with the cookie. The Web server 3 operates as a Web server by executing the service program and the user authentication program after loading these programs onto the RAM thereof.

Further, the hard disk drive of the Web server 3 stores user information 31 regarding the user of the service provided by the Web server 3.

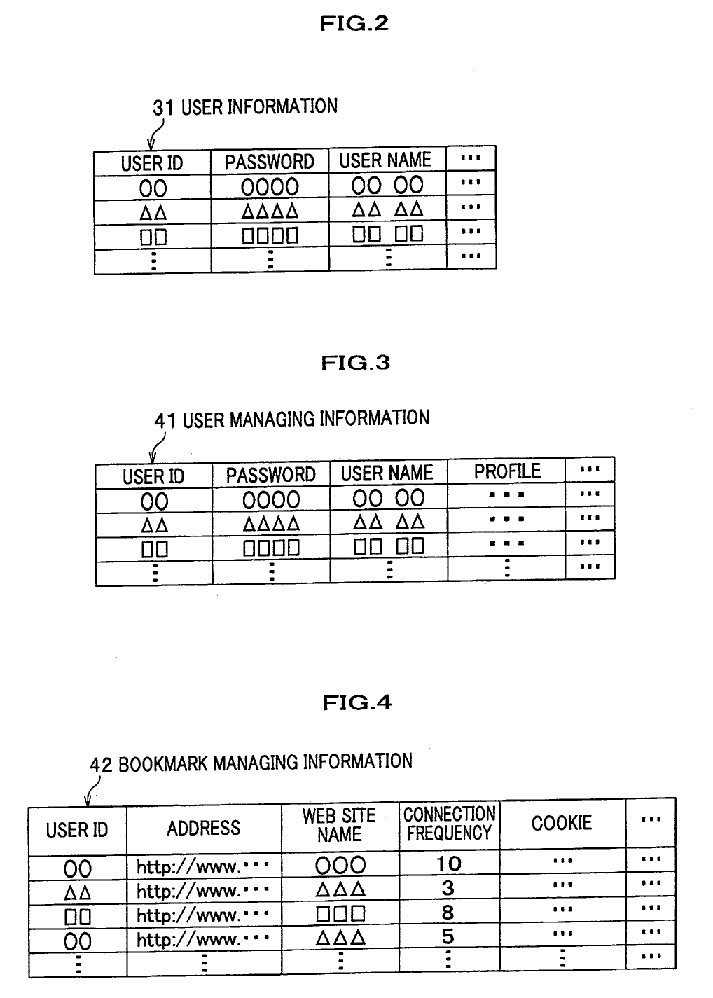

FIG. 2 is a table indicating information included in the user information 31. As shown in FIG. 2, the user information 31 includes information regarding users accessible to the service of the Web server 3, i.e., a password, and a user name associated with each user. The user information 31 is previously registered by a manager of the Web server 3 before the service of the Web server 3 is used.

The Web server 3 according to the embodiment performs the user authentication with the cookie. However, the present invention is not limited to this as long as the Web server 3 has a program for providing a service using the cookie.

Bookmark Managing Apparatus

The bookmark managing apparatus 4 is, similarly to the Web server 3, a terminal having storage devices including a RAM, a ROM, and a hard disk drive, a CPU, and a LAN card for communication interface to supply a service to the user through the network 5. For example, the server type of computer can be used as the bookmark managing apparatus 4.

The hard disk drive of the bookmark managing apparatus 4 stores records (pieces) of a user managing information 41, each including a password, a profile of the user and the like associated with a user ID (identification) unique to each user and bookmark managing information 42 including, for each user, address information of a bookmark, a Web site name, a connection frequency, a cookie associated with the address information, and the like. Here, it is assumed that the cookie associated with the Web server 3 includes at least a user ID and a password.

In addition, the hard disk drive of the bookmark managing apparatus 4 stores a user authentication program for authenticating the user currently using the user terminal 2, a bookmark managing program for registering the bookmark managing information 42, and a connection managing program for managing connection between the user terminal 2 and the Web server 3 via the bookmark managing apparatus 4 as a proxy server. The bookmark managing apparatus 4 operates by executing the bookmark managing program and the connection managing program loaded onto the RAM thereof by the CPU.

Here, the hard disk drive in the bookmark managing apparatus 4 corresponds to storing means in the claims of the present invention, and executing the user authenticating program, the bookmark management program, and the connecting management program provides authenticating means, bookmark managing means, connecting managing means in claims of the present invention.

FIG. 3 shows an example of information stored in the user managing information 41. As shown in FIG. 3, the user managing information 41 includes information of users accessible to the service of the bookmark managing apparatus 4, the information including a password, a user name, a profile of the user, associated with the user ID unique to each user. Here, the user ID and the password in the user managing information 41 may be the same or different from those in the user information stored in the Web server 3. The user managing information 41 is registered before the bookmark managing apparatus 4 is used.

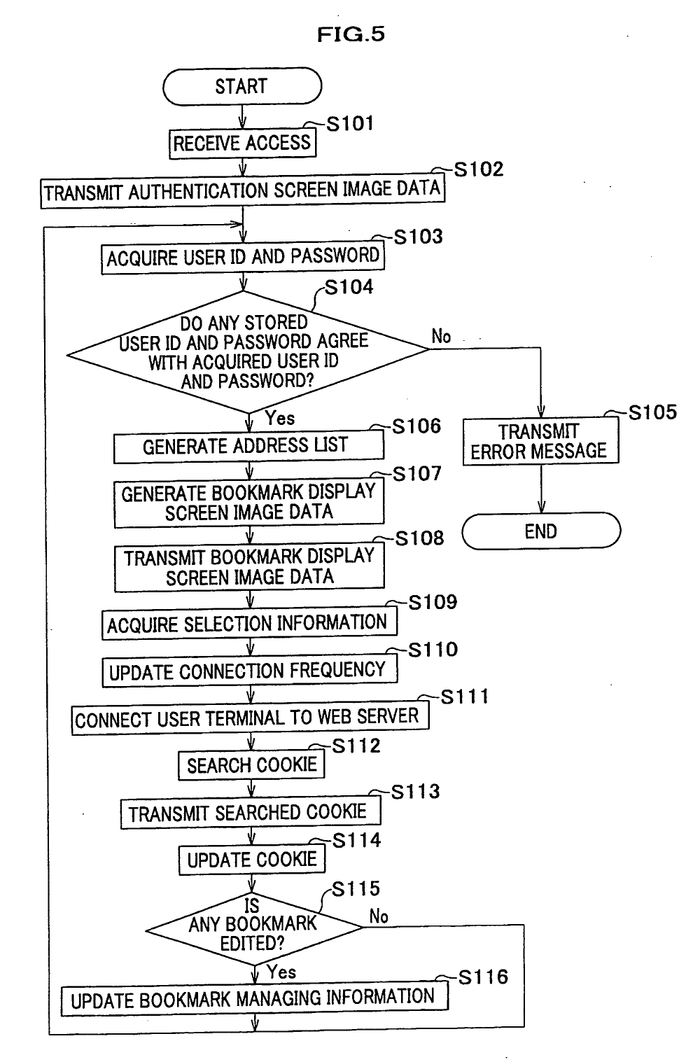

FIG. 4 shows an example of information recoded in the bookmark managing information 42 The bookmark managing information 42 shown in FIG. 4 is used to generate an address list as bookmarks obtained from the user terminal 2 by a process mentioned later, and stores records (pieces of the bookmark managing information), each including an address as information for connecting to the Web server 3, a Web site name, and the cookies transmitted from the Web server 3, a frequency of connection to the Web server 3, and the like, associated with the user ID of each user.

Each record of the bookmark managing information 42 is generated as follows:

When the user makes a bookmark to store an address and an associated site name to be displayed during an operation of the browser, the bookmarked address, the site name, and an associated cookie are transmitted to the bookmark managing apparatus 4. In response to this, the bookmark managing apparatus 4 stores the address, the site name and the associated cookie in the bookmark managing information 42. Preferably, the bookmarked address, site name, associated cookie are transmitted with a special program.

Further, in the network system 1 according to the embodiment, preferably, the information used in authentication transmitted between the user terminal 2 and the bookmark managing apparatus 4 and between the bookmark managing apparatus 4 and the Web server 3 is encrypted for transmission and reception by SSL (Secure Socket Layer).

Operation of Bookmark Managing Apparatus

Hereinafter, will be described in details a method of a managing bookmark with the bookmark managing apparatus 4 in the network system 1.

First, the bookmark managing apparatus 4 generates the address list 61 from the bookmark managing information 42 for each user. More specifically, the bookmark managing apparatus 4 selects the records having the same user ID and generates the address list 61 of each user ID to provide a screen image of records, vertically arranged on the bookmark display screen image 60 of the user terminal 2, each record includes a site name, an address, and not-displayed selection data linked to the address data.

FIG. 5 depicts a flowchart of the bookmark managing apparatus 4. The user accesses the bookmark managing apparatus 4 from the user terminal 2 which is the same as or different from the user's own user terminal 2. When receiving an access, the bookmark managing apparatus 4 performs the user authentication with the user authentication program (a step S101). Then, the bookmark managing apparatus 4 transmits to the user terminal 2 authentication screen image data for displaying an authentication screen image including a box for entering the user ID and a password (a step S102). The user enters the user ID and the password on the authentication screen image at the user terminal 2 to transmit the user ID and the password to the bookmark managing apparatus 4. In response to this, the bookmark managing apparatus acquires the user ID and the password (a step S103), collates the acquired user ID and password with the user IDs and the passwords stored in the user managing information 41 to determine whether the user managing information includes any user ID and any password identical with the acquired user ID and the password (a step S104).

When the user managing information includes no user ID and no password identical with the acquired user ID and password (No in step S104), the processing is finished after transmitting an authentication error message (a step S105).

When the user managing information includes a user ID and a password identical with the acquired user ID and password, the bookmark managing apparatus 4 proceeds to a step S106.

In the step S106, the bookmark managing apparatus 4 generates a list of addresses from records associated with the user ID acquired in the step S103 (a step S106) and bookmark screen image data on the basis of the address list of the bookmarks (a step S107). Data of each record of the address list in the bookmark displays screen image data includes an address (address data) and a site name of the Web server 3 (site name data), and not-displayed selection data for identifying the associated Web server 3, linked to the address data and the site name data.

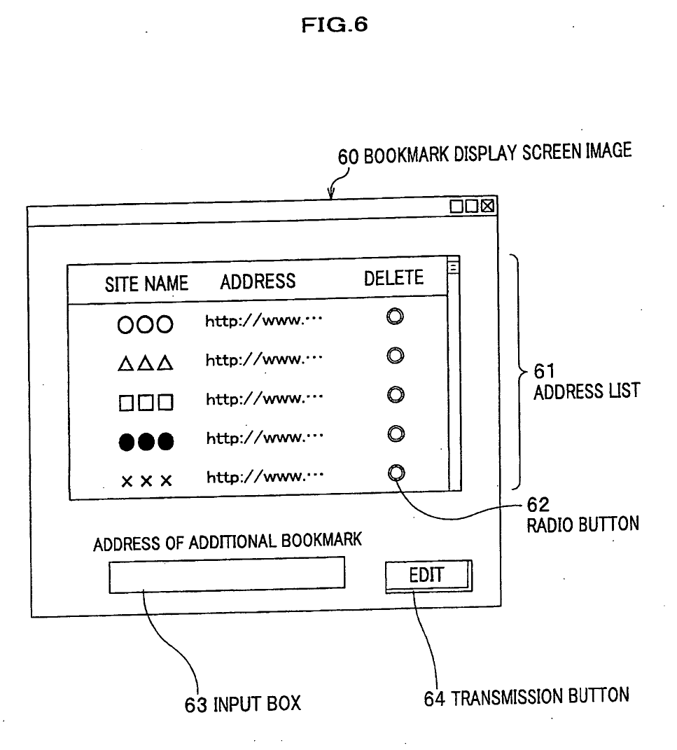

Next, the bookmark managing apparatus 4 transmits the bookmark screen image data to the user terminal 2 (a step S105). Then, the user can select the addresses of the desired Web server 3 with observing the bookmark display screen image 60 displayed on the user terminal 7. FIG. 6 shows an example of the bookmark screen image 60. As shown in FIG. 6, on the bookmark display screen image 60 is displayed an address list 61 including the records, each including the site name, the associated address, and a radio button 62 selectively used for deleting the record. In addition, at a lower part of the bookmark display screen image 60, an input box 63 is arranged for entering an address of an additional bookmark. On the right of the input box 63 is provided a transmission button 64 which is pressed when input information on the bookmark display screen image 60.

Further another input box (not shown) for inputting a cookie may be provided to input the cookie corresponding to the Web page address.

When the address of the Web server 3 on the bookmark display screen image 60 displayed on the user terminal 2 is clicked, the selection information linked to the address is transmitted to the bookmark managing apparatus 4. When acquiring and receiving the selection information (a step S109), the bookmark managing apparatus 4 updates the connection frequency of the bookmark managing information 42 (a step S110) and makes a connection between the user terminal 2 and the Web server 3 corresponding to the selection information by a relaying operation (a step S111).

More specifically, the bookmark managing apparatus 4 searches the bookmark managing information 42 for the address of the Web server 3 to be connected and the associated cookie (step S112) to accesses to the Web server 3 and transmits the searched cookie in response to a request from the Web server 3 (a step S113).

Next, the Web server 3 performs the user authentication by determining whether the user information 31 includes information associated with the user ID and the password included in the cookie with the user authentication program. When the user authentication is successful, the Web server 3 provides the service to the user terminal 2. The bookmark managing apparatus 4 updates the cookie in the bookmark managing information 42 with another cookie transmitted from the Web server 3 during communication between the user terminal 2 and the Web server 3 (step S114). Further, the bookmark managing apparatus 4 can transmit the updated cookie in response to a request from the Web server 3.

Next, the bookmark managing apparatus 4 determines whether or not any bookmark is edited on the bookmark display screen image 60 (a step S115). Whenever any edition of the bookmarks such as addition and deletion is performed on the bookmark display screen image 60, communication between the user terminal 2 and the bookmark managing apparatus 4 is made and data regarding the edition is transmitted to the bookmark managing apparatus 4 as edition information.

When the edition is made (Yes in the step S115), the book mark managing apparatus 4 updates the bookmark managing information 42 by adding a new address as a bookmark or deleting an address in accordance with the edition information (step S116). As a result of updating the bookmark managing information 42, the bookmark managing apparatus 4 will generate a new address list 61 in which addresses are sorted in accordance with the connection frequencies to the addresses when the step S106 is executed. After updating the bookmark managing information 42 and the address list 61, processing returns to the step S103 to repeat the aforementioned process.

In the step S115, if no edition is made (No in the step S115), the processing in the step S116 is skipped and returns to the step S103.

As mentioned above, according to the bookmark managing apparatus 4 and the method of managing the bookmark, the user can use the bookmarks in the bookmark managing apparatus 4 although the user accesses to the network 5 with the user terminal 2 other than the user terminal 2 owned by the user. Further, although the user accesses the Web server 3 with the user terminal 2 other than the user terminal 2 owned by the user, the user can receive the service with the same cookie as long as the Web server 3 uses the cookies. For example, if the cookie includes user's authentication information, the user can omit authentication for accessing to the Web server 3 by accessing to the Web server 3 via the bookmark managing information using any given user terminal 2 with a result of a largely reduced load on the user.

In the embodiment, as mentioned above, the programs for the bookmark managing apparatus 4 are stored in the hard disk drive. For this, these programs are read out from a CD-ROM including these programs and installed in the hard disk drive. Further, these programs can be read for installation from a computer-readable recording medium such as a flexible disk, and an IC card. In addition, these programs can be down-loaded through the network 5.

Modifications

The present invention can be modified.

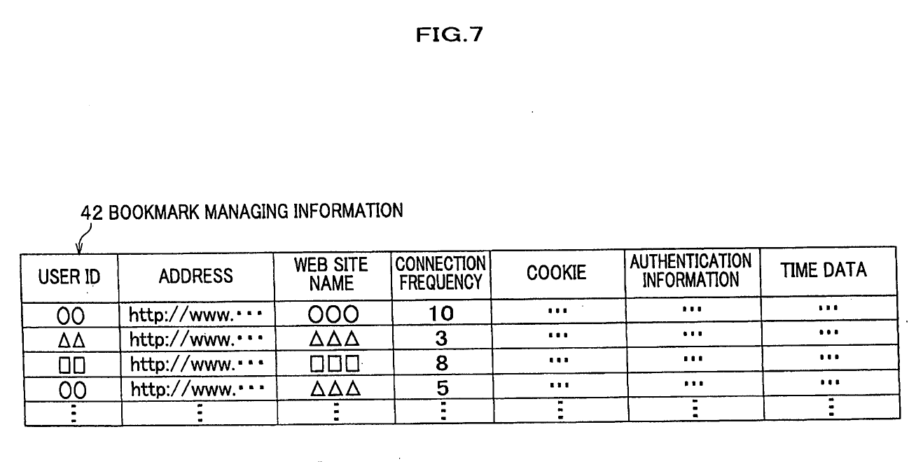

For example, each record of the bookmark managing information 42 stores a connection date and time in addition to the connection frequency. FIG. 7 shows a table of bookmark managing information stored in the bookmark managing apparatus 4 according to such a modification of the present invention. The bookmark managing information 42 further includes authentication information, such as the user ID, the password, the user name, and an email address, and time data.

Further, in the embodiment, the cookie is stored in the bookmark managing information 42. In addition to this, the authentication information such as the user ID, the password, and the like may be stored in the bookmark managing information 42, and in response to a request the Web server 3, the bookmark managing apparatus 4 transmits the authentication information.

Further, in the embodiment, the address list 61 is edited by the user and a display order of the bookmarks is determined on the basis of the connection frequency. Thus, a predetermined number or a selected number of the bookmarks having high connection frequencies are displayed on a first page of the address list 61. However, the bookmarks may be sorted Or selected by the bookmark managing apparatus 4 or a manager or an operator of the bookmark managing apparatus 4 Or automatically on the basis of the profile of the user in the user managing information 41. For example, the bookmarks may be sorted or selected on the basis of an age of the user as sorting information.

Further, the sorting information may be attached to the address list 61. If two types of sorting information are attached, the display mode of sorting in the user terminal 2 may be switched in response to, for example, a shift key on the keyboard.

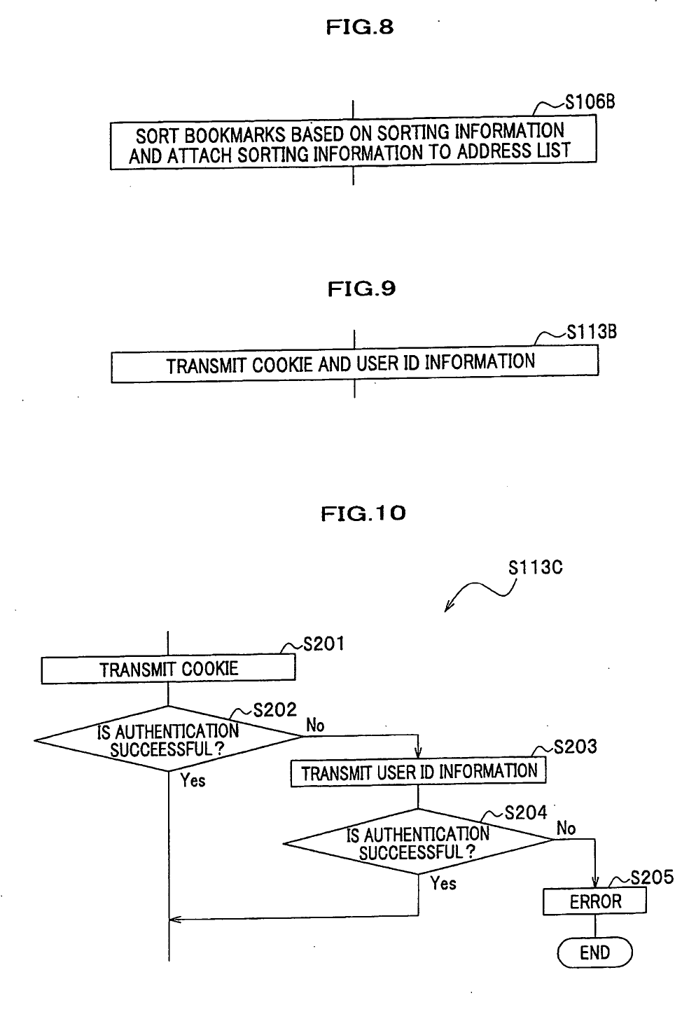

FIG. 8 shows a part of the flowchart shown in FIG. 5 as a modified step S106B replacing the step S106. In the step 106B, the bookmark managing apparatus 4 sorts the bookmarks on the basis of the sorting information and attaches the sorting information to the address list 61.

Further, predetermined bookmarks may be deleted by the bookmark managing apparatus 4 or the manager of the book mark managing apparatus 4 on the basis of the sorting information.

In the embodiment, the cookies are stored in the bookmark managing information 42. However, in addition to this, when transmitting the cookie in the step S113 in response to a request of the Web server 3, the bookmark managing apparatus 4 may transmit authentication information for the Web server 3 such as the user ID and the password.

FIG. 9 shows such a modification in which the step S113 of the flowchart shown in FIG. 5 is replaced with a modified step S113B. The bookmark managing apparatus 4 transmits the cookie and authentication information at the same time or at different time.

FIG. 10 shows a part of the flowchart shown in FIG. 5 as a modified step S113C replacing the step S113. After the step S112, the bookmark managing apparatus 4 transmits the cookie in a step S201. The bookmark managing apparatus 4 checks whether authentication by the Web server 3 with the cookie in a step 5202 is successful. If the authentication by the Web server 3 with the cookie is successful, the bookmark managing apparatus 4 proceeds to the step S114 in FIG. 5 If the authentication by the Web server 3 with the cookie is unsuccessful in step S202, the bookmark managing apparatus 4 transmits the user ID information to the Web server 3 for another type of authentication in a step S203. The bookmark managing apparatus 4 checks whether another type of authentication by the Web server 3 is successful in a step S204. If another type of the authentication by the Web server 3 is successful in the step S204, the bookmark managing apparatus 4 proceeds to the step S114 in FIG. 5. If another type of the authentication by the Web server 3 is unsuccessful in the step S204, the bookmark managing apparatus 4 transmits an error message to the user terminal 2 in a step S205 and ends the processing. Further, a still another type of the authentication may be performed.

In the embodiment, the bookmark managing apparatus 4 transmits data of the bookmark display screen image 60 to the user terminal 2. However, for example, a plug-in module for synchronizing the bookmark managing information 42 with the bookmarks in the user terminal 2 is installed in the Web browser of the user terminal 2 to transmit synchronizing data of the bookmark to the bookmark managing information. 42 whenever the user terminal 2 connects to the network 5. The bookmark managing apparatus 4 receives the synchronizing data to add or delete a bookmark in accordance with the synchronizing data.

In this event, for example, when the plug-in module is installed in the user terminal 2, the user terminal 2 acquires the authentication information from the user to store the authentication information therein. When the user logs in the bookmark managing apparatus 4, the plug-in module in the user terminal 2 transmits the stored authentication information to perform the user authentication. Thus, the user can use the bookmark of the user stored in the bookmark managing apparatus 4 without reentering the authentication of the user.

In addition, for example, the network system 1 may be configured as follows:

The user IDs sharing the bookmark are stored in the bookmark managing apparatus 4 as sharing information (user ID is related to the bookmark) in order that a plurality of users share the bookmark on the basis of the sharing information. Each of the users sharing the bookmark can edit the bookmark on the bookmark display screen image 60 (see FIG. 6) to reflect the edition in the shared bookmark.

Further, this may be modified as follows:

Without storing the sharing information in the bookmark managing apparatus 4, a special plug-in module is installed in the user terminals 2 to similarly share the bookmark among a plurality of user terminals 2 in which the special plug-in module is installed.

In the embodiment, the user terminal 2, the bookmark managing apparatus 4 and the Web server 3 are connected to the same network 5. However, the present invention is not limited to this. For example, the user terminal 2 is connected to the bookmark managing apparatus 4 through another network or a LAN (not shown) or a special line which is different from the network 5.

Further, the bookmark display screen image 60 can be displayed on a pop-up screen image which is different from the screen image of the Web browser.

According to the present invention, though the user accesses the Web server 3 with another terminal 2, the user can use the cookie of the user, so that the load on the user in the user authentication can be reduced.

In addition, the collected information such as the user managing information 41 and the bookmark managing information 42 can be used for marketing as a secondary use after a statistical process.

The invention claimed is:

1. A bookmark managing apparatus, connectable to a server that provides a service through a network and to a terminal of a user, for managing a bookmark for each user, comprising:
storing means for storing at least a piece of bookmark managing information including user identification information for identifying the user, connection information associated with the user identification information for connection to the server, and a cookie of the server associated with the user identification information;
authenticating means for authenticating the user by collating user identification information received from the terminal of the user with the stored user identification information;
bookmark managing means for, when authenticating the user is successful, searching a piece of the bookmark managing information associated with the user identification information received from the terminal of the user to generate a list of the connection information of the user to transmit the list to the terminal; and
connecting management means for connecting the bookmark managing apparatus to the server with the connection information associated with the user when selection information indicating that the connection information is selected is received from the terminal of the user to cause the server to provide data of the service to the terminal of the user and for transmitting the cookie to the server when receiving a request for transmitting the cookie.

2. The bookmark managing apparatus as claimed in claim 1, wherein the bookmark managing means comprises editing means for further storing a piece of the bookmark managing information including user identification information for identifying the user in response to a request for additional storing the bookmark managing information from the terminal and deleting a piece of the bookmark managing information in response to a request for deletion of the bookmark managing information from the terminal.

3. A method of managing a bookmark of a server for providing a service to a terminal of a user through a network, comprising the steps of:
storing at least a piece of bookmark managing information including user identification information for identifying the user, connection information associated with the user identification information for connection to the server, and a cookie of the server associated with the user identification information;
authenticating the user by collating user identification information received from the terminal of the user with the stored user identification information;
when authenticating the user is successful, searching a piece of the bookmark managing information associated with the user identification information received from the terminal of the user to generate a list of the connection information of the user to transmit the list to the terminal; and
making a connection to the server with the connection information associated with the user when selection information indicating that the connection information is selected is received from the terminal of the user to cause the server to provide data of the service to the terminal of the user and transmit the cookie to the server when a request for transmitting the cookie is received.

4. The method as claimed in claim 3, further comprising the step of: further storing a piece of the bookmark managing information including user identification information for identifying the user in response to a request for additional storing the bookmark managing information from the terminal and deleting a piece of the bookmark managing information in response to a request for deletion of the bookmark managing information from the terminal.
